(19) United States
(12) Patent Application Publication
(10) Pub. No.: US 2004/0084577 A1
(43) Pub. Date: May 6, 2004

(54) Decoy stand

(76) Inventor: Kevin J. McMahan, Vancouver, WA (US)

Correspondence Address: KOLISCH HARTWELL, P.C., 520 S.W. YAMHILL STREET, SUITE 200, PORTLAND, OR, 97204, US

(21) Appl. No.: 10/695,059

(22) Filed: Oct. 27, 2003

Related U.S. Application Data
(60) Provisional application No. 60/422,299, filed on Oct. 29, 2002.

(51) Int. Cl. F16L 3/00

(52) U.S. Cl. 248/121

(57) ABSTRACT

A decoy stand that includes a base, a pivot rod extending substantially normal to the base, a mounting bracket configured to couple with a decoy and pivot about the pivot rod, and an arm extending from the base coupling the pivot rod to the base and configured to bend to provide a first motion to the decoy.

### CROSS-REFERENCES

This application claims priority from U.S. Provisional Patent Application Serial No. 60/422,299 entitled “Decoy Stand,” filed Oct. 29, 2002.

### FIELD OF THE INVENTION

The invention relates to a decoy stand. More particularly, the invention relates to a decoy stand that for waterfowl decoys providing realistic decoy motion.

### BACKGROUND

Waterfowl decoys are well known and have been used by hunters to attract game birds for a very long time. The more realistic and lifelike the waterfowl decoy, the better the decoy will be at attracting game. Decoys that simulate both walking and feeding activities of waterfowl in a natural environment are used to attract waterfowl. Attracting waterfowl is one of the more difficult aspects of hunting and requires a skillfully set spread of lifelike decoys.

For waterfowl hunters, the critical part of any decoy is the ability to simulate lifelike natural movement comparable to that of live animals. No matter how realistic the decoy, it is crucial that the decoy appears natural and safe to attract waterfowl, turkey and other animals to the target area. With increasing hunting pressure, waterfowl and other animals are extremely suspicious and sensitive to decoys that lack realistic movement. The lack of lifelike decoy movement means danger to game animals, which alerts them to the potential of human presence.

For this reason, hunters employ a number of methods to create a realistic environment and avoid spooking the game. For example, hunters will often use certain calls (duck, goose, elk, turkey, etc.) that simulate the sounds of the quarry being pursued. Typically, hunters wear camouflage clothing and use blinds to conceal their presence from the game. Some of the most effective tools in the hunter's arsenal are decoys that simulate live birds.

Good decoys can lure the quarry being hunted into shotgun or camera range. These decoys are critical to ensuring that a natural and safe environment exists for the waterfowl to land at the target location. Decoys that provide natural lifelike movements are enormously valuable assets for any waterfowl hunter, or photographer.

In addition, many homeowners enjoy using waterfowl and related bird lawn ornaments to decorate the landscape around their homes. Certainly, the addition of lifelike movement adds to landscape designs that incorporate waterfowl of other animal-decorations.

Over the last few years, efforts have been made to address the lifeless movement of conventional waterfowl decoys. As described above, a motionless decoy implies a lack of life and frightens educated waterfowl. This problem has become more extreme in recent years due to increased hunting pressure and the increased longevity of waterfowl. By many accounts, waterfowl in many parts of the country now have a lifespan of more than twenty years. This amount of education and experience has led to waterfowl becoming continually more difficult to lure into hunting range.

Great efforts have recently been made to achieve more life-like decoys in recent years. Manufacturers such as Dave Smith, Hard Core Goose Decoys, Bigfoot Decoys, Realgeese Decoys and Higdon Decoys, have continued to manufacture more and more realistic decoys. These decoys are an improvement over previous designs due to their more anatomically correct postures, better painting schemes, colors that more closely correspond to the real bird, photographic images in some cases, and a variety of poses. However, while the overall appearance of decoys has vastly improved, relatively little work has been put into actually creating lifelike movement of waterfowl and other decoys.

Most hunters believe lifelike movements to be the most important element in luring educated waterfowl to a decoy spread. In fact, many hunters using stuffers (taxidermy mounted waterfowl) in their hunting spreads report live birds flaring off of these decoys due to their lack of natural movement.

It may be desirable to provide a decoy stand configured to enable waterfowl decoys with a very lifelike appearance to also have very lifelike movements.

### SUMMARY

A decoy stand comprising a base, a pivot rod extending substantially normal to the base, a mounting bracket configured to couple with a decoy and pivot about the pivot rod, and an arm. The arm of the decoy stand extending from the base coupling the pivot rod to the base and configured to bend to provide a first motion to the decoy.

### BRIEF DESCRIPTION OF THE DRAWINGS

FIG. 1 is an isometric view of a decoy and a decoy stand according to one embodiment of the present invention.

FIG. 2 is an assembly view of the decoy stand of FIG. 1.

FIG. 3 is a side view of the decoy stand of FIG. 1.

FIG. 4 is a top view of the decoy stand of FIG. 1.

FIG. 5 is a side view of a cross piece of the decoy stand of FIG. 1.

FIG. 6 is a side view of the cross piece of the decoy stand of FIG. 1, showing a cantilevered arm flexing up and down.

FIG. 7 is a cross-section taken along line 7-7 of the cross piece of FIG. 6, showing the cantilevered arm twisting along the arm's long axis.

FIG. 8 is a side view of the decoy stand of FIG. 1, showing a control mechanism locking the stand to prevent motion in the support arm.

FIG. 9 is a side view of a decoy stand of FIG. 1, showing a control mechanism limiting the movement of the support arm.

FIGS. 10 is a top view of a decoy mounted on the decoy stand of the present invention, showing the decoy's rotation about a vertical axis.

FIG. 11 is a schematic view of another embodiment of a decoy stand and decoy according to the present invention.

FIG. 12 is a side assembly view of the decoy stand of FIG. 11.

### DETAILED DESCRIPTION

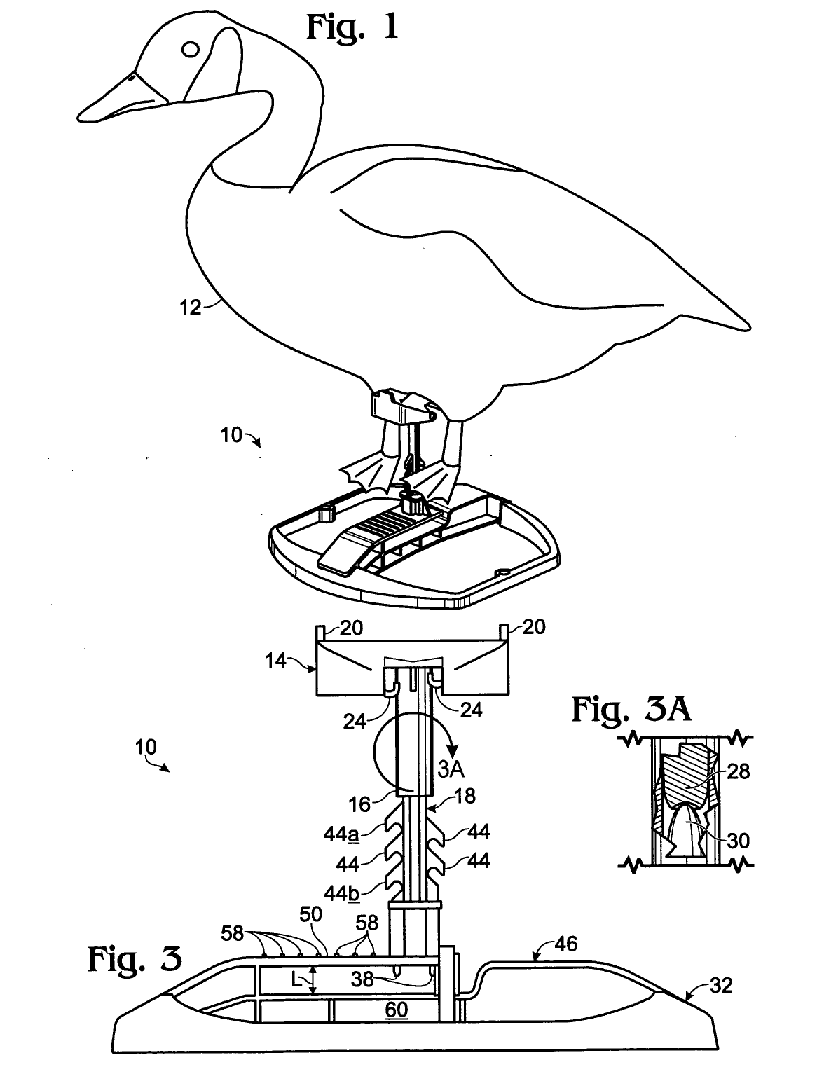

A decoy stand according to an embodiment of the present invention is generally indicated at 10 in FIG. 1. A decoy 12 is shown mounted on decoy stand 10. Decoy stand 10, when placed in a decoy set, or spread, in a hunting environment, enables decoy 12 to respond to wind forces by moving with three degrees of freedom. Decoy stand 10 pivots about a generally vertical axis, bends forward and rearward, and tilts side-to-side. Each of these movements and the structures that enable them will be discussed in more detail below.

Decoy 12 may be any game bird decoy including turkey, waterfowl, or other migratory birds. It will be understood; any type of wildlife decoy, yard decorations, or similar item may be used in connection with decoy stand 10. Scarecrows, replica dogs, replica cats, or other statuary commonly used to scare rodents and other vermin from gardens may also be used with decoy stand 10.

FIG. 2 shows an assembly view to the decoy stand of FIG. 1. Decoy stand 10 includes a mounting plate 14 configured to attach decoy 12 to stand 10. Mounting plate 14 may include a pivot sleeve 16 configured to receive a pivot rod 18 that extends generally vertically. Pivot sleeve 16 may be configured to pivot relative to pivot rod 18. Mounting plate 14 may include alignment tabs 20 configured to aid in mounting decoy 12 to stand 10. Apertures 22 extend through mounting plate 14 to receive fasteners for securing decoy 12 to stand 10. Mounting plate 14 may include retainer hooks 24, or other suitable retention structure for securing a biasing member 26.

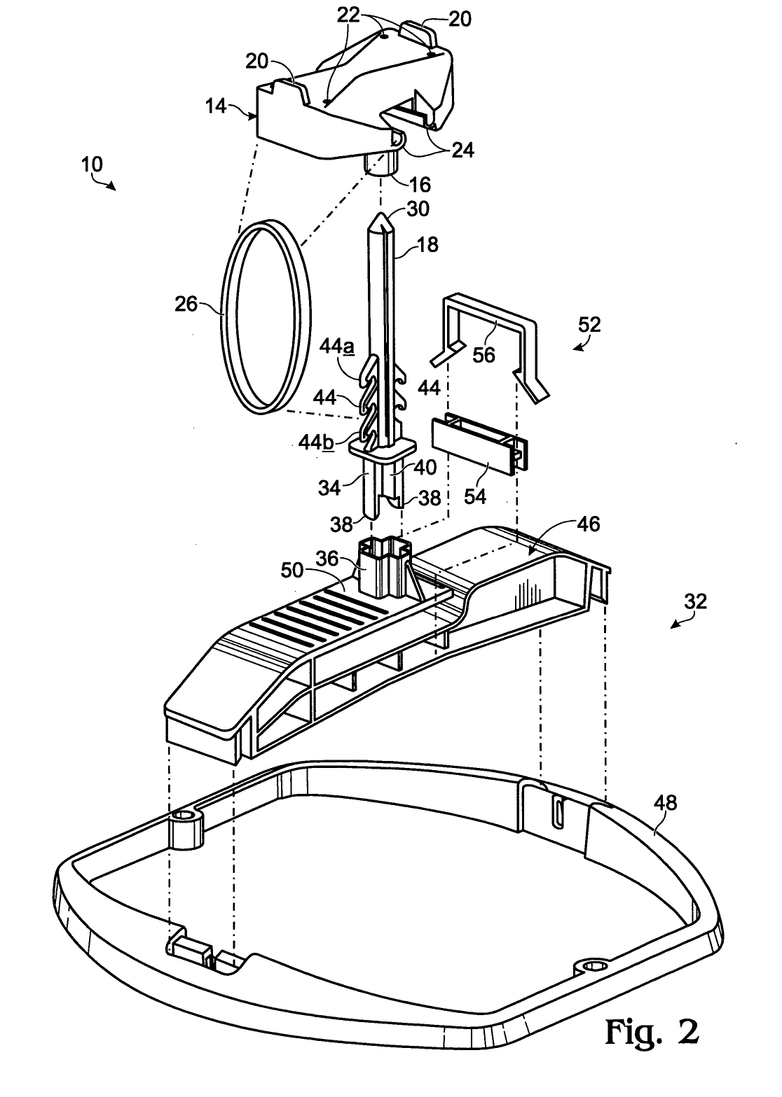

Pivot sleeve 16 extends generally downward from mounting plate 14. Typically, pivot sleeve 16 is cylindrical and hollow. However, other shapes, configurations, and designs may be suitable for pivot sleeve 16. Mounting plate 14 may include a cup 28 positioned within sleeve 16 configured to receive a rounded tip conical end 30 of pivot rod 18, as shown in FIG. 3A. It should be understood that rounded tip conical end 30 may be other shapes. Cup 28 may be configured to receive end 30 and the shapes may be complementary and configured to reduce the amount of friction between pivot rod 18 and mounting plate 14. It may be desirable to reduce friction so that light forces applied to mounting plate 14 may induce relative pivotal motion between the mounting plate and pivot rod 18.

Alignment tabs 20 of mounting plate 14 may be adapted to fit the bottom of decoy 12. Typically, decoy 12 includes complementary structure for receiving the alignment tabs. It should be understood that the shape of alignment tabs 20 by depend on what type of decoy will be used with decoy stand 10. A series of different mounting plates may be used with decoy stand 10 to accommodate different types of decoys. For example, goose decoys are larger than duck decoys and may require a different configuration for mounting plate 14. Similarly in different applications, for example, lawn decorations at different mounting plate may be used.

Any suitable fastener may be used for securing decoy 12 to mounting plate 14. Typically, screws are used to secure decoy 12 to mounting plate 14 through apertures 22, but other fastening structures may be used. For example, a quick lock, or snap in type structure may be included on mounting plate 14 that works with a complimentary structure on decoy 12.

Retainer hooks 24, or retention structure 24, may be located on a lower side of mounting plate 14. Mounting plate 14 may include a plurality of retainer hooks 24, located on the lower side. It should be understood that any suitable structure may be used to retain biasing member 26. As shown in FIG. 2, biasing member 26 is an elastomeric band. It should be understood that any suitable biasing member may be used and that the size, shape, position, or other features of retainer hooks 24 may change to accommodate different biasing members.

Pivot rod 18, as noted above, extends generally vertically from a base 32 of decoy stand 10. Pivot rod 18 pivotally couples with mounting plate 14 via insertion into pivot sleeve 16 of mounting plate 14. Pivot rod 18 may include an attachment structure 34 configured to fit into a corresponding receiving structure 36 of base 32. Typically, attachment structure 34 includes one or more prongs 38 and alignment tabs 40 that are configured to insert into an alignment opening 42 shaped to receive prongs 38 and alignment tabs 40. Attachment structure 34 and receiving structure 36 are configured to be releasable.

Prong 38 extends from attachment structure 34 on a coupling end of pivot rod 18 to releasably attach the pivot rod with a support arm. Typically, attachment structure 34 is a male-type key structure shaped to mate with a corresponding female-type key structure of the receiving structure 36.

Pivot rod 18 may include one or more hooks 44, or retainer notches configured to secure biasing member 26 to the pivot rod. Hooks 44 may be positioned at discrete distances from end 30 of rod 18 to enable pretension adjustments to the biasing member. For example, in condition where wind forces are light the biasing member may be attached to the pivot rod at hook 44a, which is located closest to end 30 of pivot rod 18, resulting in light pretension in the bias member. . In heavy wind conditions where the wind forces are strong, biasing member 26 may be attached to hook 44b, which is furthest from the end 30 of pivot rod 18. The biasing member may be attached to any of hooks 44 between the two extremes 44a and 44b to provide the proper pretension in other wind conditions.

Base 32 of stand 10 includes a cross member 46 that extends through the center of a ring member 48. Cross member 46 passes through a center region contained within ring member 48 providing support for pivot rod 18. Ring member 48 may include one or more apertures 49 for staking the base to the ground for more support, or to secure the decoy in high wind conditions. It should be noted that the size of base 32 will depend on the size of the decoy to be supported and the configuration of

Cross member 46 includes a support arm 50 configured to include base attachment structure 36 for securing pivot rod 18 to base 32. Support arm 50 may be configured to bend and flex in two ways, as clearly shown in FIGS. 6, 7 and 9. The bending and flexing of support arm 50 causes decoy 12 to move in life like ways. For example, bending of support arm 50 as illustrated in FIGS. 6 and 9, simulates a forward and rearward feeding motion in decoy 12. Twisting or flexing along a long axis of support arm 50 creates a side-to-side waddle or walking motion in decoy 12, as illustrated in FIG. 7.

FIG. 2 further illustrates, a control mechanism 52 may be used to limit the movement of support arm 50. Control mechanism 52 includes a block 54 sized to fit between support arm 50 and cross member 46 to selectively limit the bending of support arm 50. Control mechanism 52 further includes a clip 56 configured to fit over support arm 50 and secure block 54 in place to prevent movement of the block. Support arm 50 may include one or more discrete ridges 58, or similar structure in order to position clip 56 and secure block 54 at a distinct location along the length of arm 50.

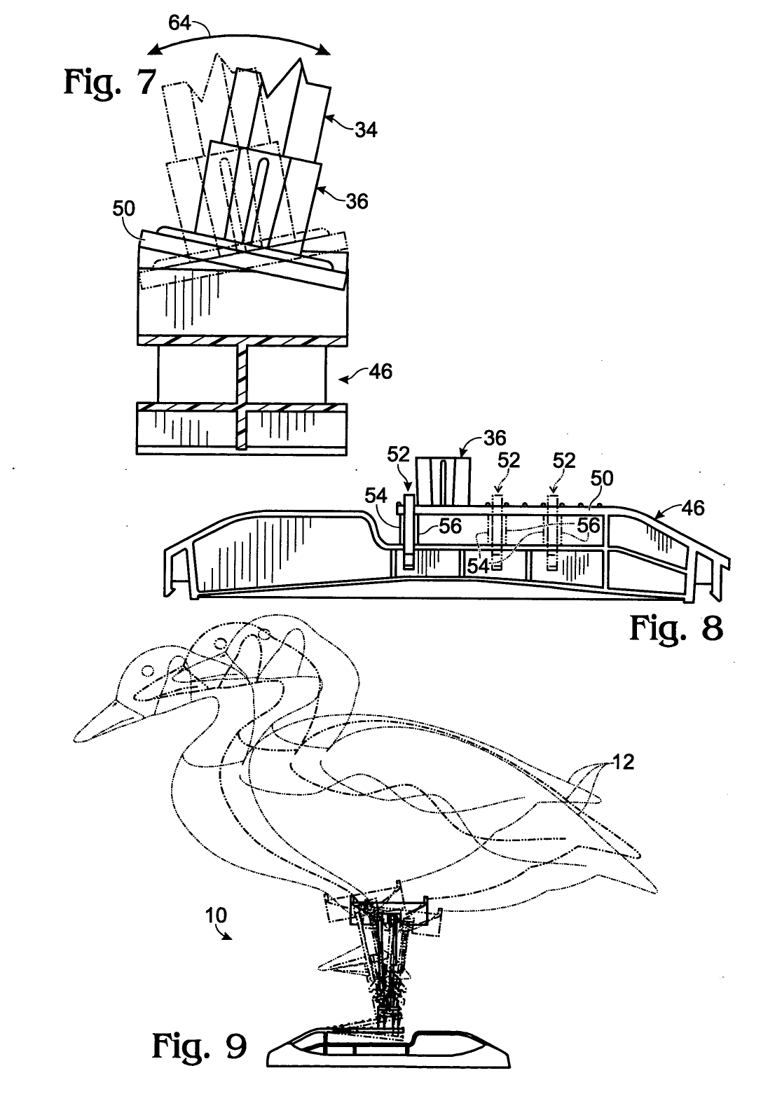

As shown in FIG. 8, varying the location of block 54 and clip 56 effectively changes the flexible length of support arm 50, which in turn limits the bending and twisting motion of the support arm. By securing block 54 at the end of support arm 50 stand 10 is effectively locked and the only movement that a decoy attached to stand 10 will experience is the pivoting about pivot rod 18. By securing block 54 between a pair of discrete ridges 58 the length of support arm 50 that remains flexible is reduced, thereby limiting the movement of a decoy mounted to decoy stand 10.

Turning to FIG. 3 a side view of stand 10 more clearly illustrates the cantilevered structure of support arm 50. Support arm 50 is spaced a distance L from a lower section 60 of cross member 46. The distance L may be selected to prevent support arm 50 from bending so much that the support arm is damaged. For example, if a hunter using decoy stand 10 accidentally steps on the decoy stand, support arm 50 will bottom out on lower section 60 of cross member 46, before the support arm bends so much that it is damaged.

FIG. 6 illustrates the bending of support arm 50, and the distance L is selected to prevent the bending from exceeding the elastic flexibility of support arm 50.

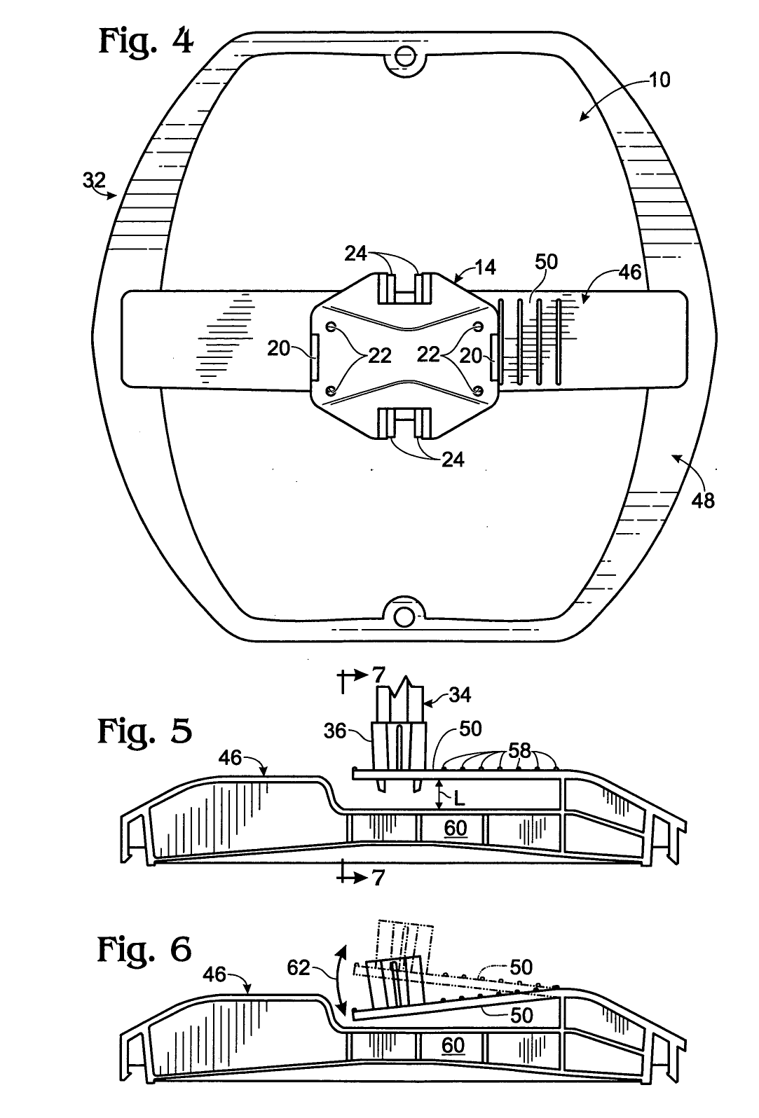

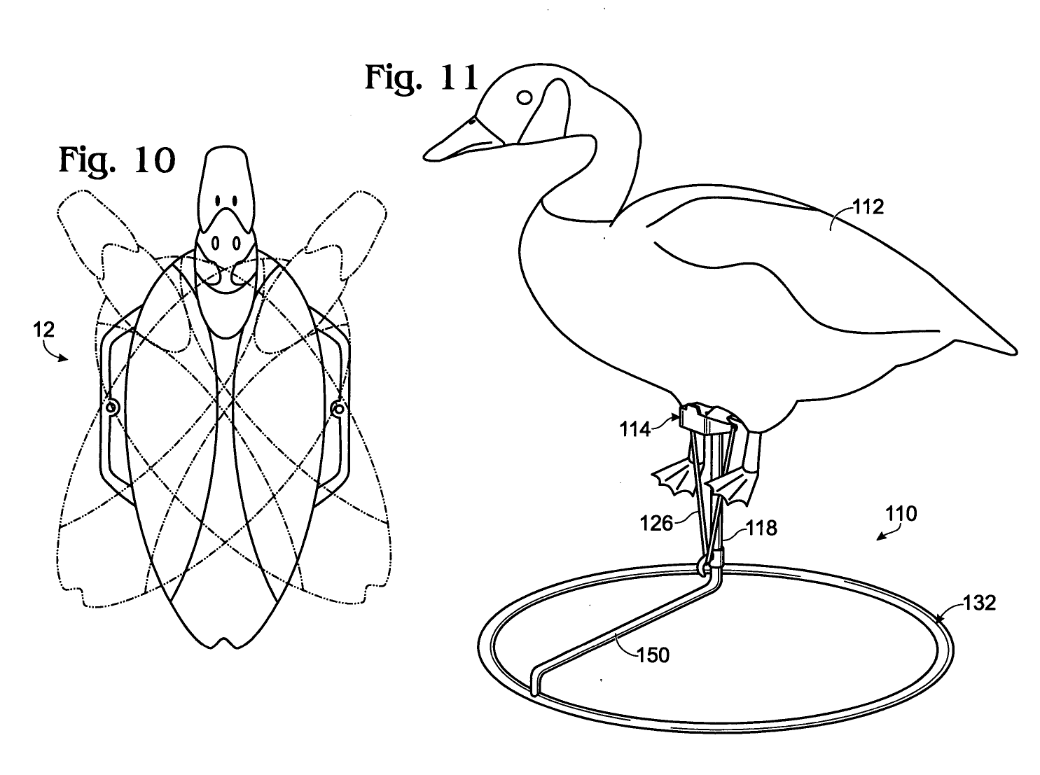

FIG. 4 illustrates the stand in a top view with all the components assembled. It can be clearly seen that base 32 is wide relative to decoy mounting plate 14. A wide base enables wind forces blowing against the side to be translated into rotation, as will be described below, with reference to FIG. 10. It should be noted that other shapes may be used for the base. For example, an H-shape may be used to provide a wide base support, or an X-shape may be used to provide a wide base support. Any suitable shaped structure that permits a vertical pivot rod near the geometric center of the base shape may be used.

FIGS. 5 and 6 illustrate a side view of cross member 46. Spacing L separating support arm 50 from the remainder of cross member 46. As shown, cross member 46 includes a web and flange structure to provide a lightweight sturdy structure to resist bending. Support arm 50 extends from the web and flange structure of cross member 46 and is configured to flex up and down, as shown by arrow 62 in FIG. 6. The relatively rigid structure of cross member 46 provides for a more consistent bending response in support arm 50 to wind forces upon decoy 12. Up ward and downward flex of support arm 50 causes decoy 12 to move in a bobbing forward and rearward motion, as shown in FIG. 9.

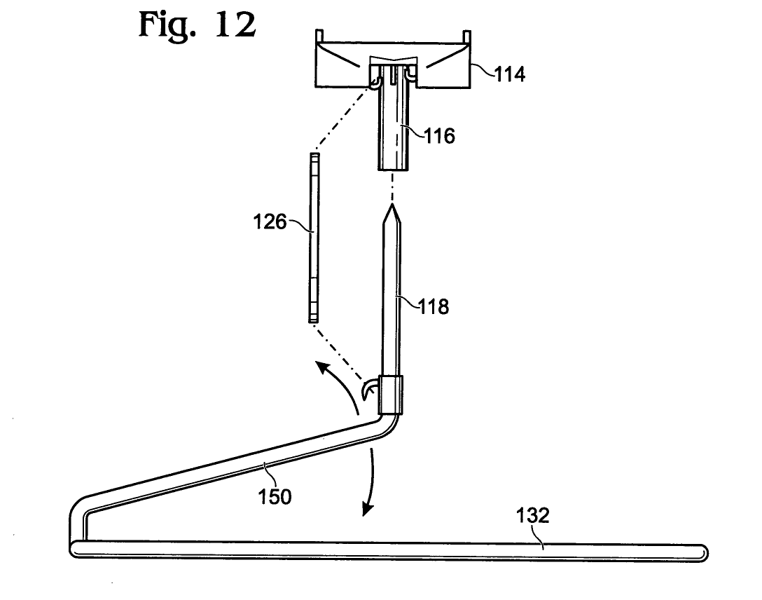

FIG. 7 shows a cross section of cross member 46. An end view of support arm 50 is illustrated. Support arm 50 may twist, as illustrated in FIG. 12 to induce side-to-side waddle type motion in decoy 12. The side-to-side motion provided by the twisting of support arm 50 simulates life-like movement of the decoy. Arrow 64, in FIG. 11, shows the side-to-side motion of the decoy.

FIG. 10 illustrates decoy 12 pivoting about pivot rod 18. As shown, winds striking the decoy cause it to rotate about pivot rod 18. Biasing member 26, as described above, attaches to mounting plate 14 and limits the pivotal rotation of decoy 12. This rotation about the vertical axis simulates life like movement in decoy 12. It should be understood that two or more biasing members may be used to limit the pivotal rotation of decoy 12. Multiple hooks are provided so that multiple biasing members may be attached in high wind conditions.

FIG. 11 illustrates another embodiment of a decoy stand according to the present invention, generally indicated at 110. Decoy stand 110 couples with a decoy 112 via mounting plate 114. Decoy stand 110 may be configured to enable decoy 112 to move in at least two degrees of freedom. Decoy stand 110 enables pivotal motion about a vertical pivot rod 118, as one degree of freedom. A biasing member 126 limits the amplitude or displacement of the rotation caused by wind forces rotating decoy 112. A ring base 132 is used to provide a solid base for decoy stand 110.

FIG. 12 further illustrates assembly of decoy stand 110. Up and down bobbing motion is shown by arrows 162, cause decoy 112 to move in a manner similar to that illustrated by FIG. 9, above. Decoy 112 may simulate a walking or feeding motion that simulates lifelike characteristics to waterfowl flying overhead.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

I claim:

1. A decoy stand comprising:
a base;
a pivot rod extending substantially normal to the base;
a mounting plate configured to couple with a decoy and pivot about the pivot rod; and
an arm extending from the base coupling the pivot rod to the base and configured to bend to provide a first motion to the decoy.

2. The decoy stand of claim 1, wherein the arm is configured to twist to provide a second motion to the decoy.

3. The decoy stand of claim 2, further comprising a control mechanism configured to selectively adjust the sensitivity of the arm to bending and twisting forces thereby damping motion in the decoy.

4. The decoy stand of claim 3, wherein the control mechanism adjusts to lock-down the arm eliminating bending and twisting motion in the arm.

5. The decoy stand of claim 4, wherein the control mechanism comprises:
a block sized to fit between the arm and the base; and
a lock clip configured to secure the block in place.

6. The decoy stand of claim 2, wherein the arm includes a cantilevered arm.

7. The decoy stand of claim 1, wherein the base includes a closed ring structure.

8. The decoy stand of claim 7, wherein the base includes a crosspiece connecting opposed sides of the closed ring, and wherein the crosspiece includes the arm configured to simulate motion under a load.

9. The decoy of claim 8, wherein the arm is spaced a distance (L) apart from the cross-piece, and wherein (L) is selected to limit the maximum displacement of the arm.

10. The decoy stand of claim 1, wherein the base includes an H-shaped structure.

11. The decoy of claim 10, wherein the base includes at least one aperture configured to accommodate a stake for securing the base.

12. The decoy stand of claim 1, wherein the pivot rod includes a rounded point end adapted to be received by a corresponding concave cup in the mounting plate to minimize the frictional resistance to pivoting.

13. The decoy stand of claim 12, further comprising a pivot resistance assembly configured to bias a mounted decoy to a predetermined orientation.

14. The decoy of claim 13, wherein the pivot resistance assembly comprises:
a biasing member;
a retention structure attached to the mounting plate configured to secure part of the biasing member to the mounting plate; and
at least one retainer notch positioned on the pivot rod configured to secure part of the biasing member to the mounting plate.

15. The decoy stand of claim 14, wherein the pivot resistance assembly includes:
a plurality of retainer notches positioned at discrete distances from the mounting bracket; and
the biasing member includes an elastic ring configured to attach to the retention structure and attached to one of the plurality of retainer notches, wherein attaching the elastic ring to a retainer notch further from the mounting bracket results in a larger magnitude bias toward the predetermined orientation.

16. The decoy stand of claim 14, wherein the pivot resistance assembly includes two biasing members.

17. The decoy stand of claim 1, wherein the pivot rod includes a releasable coupling structure and the arm includes a complementary retaining structure.

18. The decoy stand of claim 17, wherein the releasable coupling structure includes:
at least one prong extending from a coupling end of the pivot rod configured to releasably attach the pivot rod with the arm; and
a male-type key structure shaped to mate with a corresponding female-type key structure of the retaining structure.

19. The decoy stand of claim 18, wherein the corresponding retaining structure includes:
a female-type key structure shaped to receive the male-type key structure; and
at least one receiving structure configured to receive the at least one prong.

20. A decoy stand configured to respond to wind by enabling life-like motion in a decoy mounted thereon, the decoy stand comprising:
a base configured to prevent the decoy from tipping over;
a pivot rod extending substantially normal to the base and configured to enable the decoy to pivot about a substantially vertical axis;
a mounting plate configured to couple with the decoy and pivot about the pivot rod; and
an arm extending from the base coupling the pivot rod to the base and configured to bend to provide a first motion to the decoy.

21. A decoy stand configured to respond to wind by enabling life-like motion in a decoy mounted thereon, the decoy stand comprising:
a base means for preventing the decoy from falling over;
a pivot means for enabling the decoy to pivot about a substantially vertical axis;
a mounting means for coupling the decoy with the base means; and
a support means for bending to provide a first motion and a second motion to the decoy.
